(19) United States
(12) Patent Application Publication
(10) Pub. No.: US 2026/0135949 A1
(43) Pub. Date: May 14, 2026

(54) METHOD AND SYSTEM FOR ACOUSTIC COMMUNICATION OF DATA

(71) Applicant: SONOS EXPERIENCE LIMITED, Hayes (GB)

(72) Inventors: Daniel John Jones, London (GB); James Andrew Nesfield, Edinburgh (GB)

(21) Appl. No.: 19/246,546

(22) Filed: Jun. 23, 2025

Related U.S. Application Data
(63) Continuation of application No. 18/144,395, filed on May 8, 2023, now Pat. No. 12,341,931.

(51) Int. Cl. H04M 9/08; H04B 11/00; H04R 3/02

(52) U.S. Cl. CPC H04M 9/082; H04B 11/00; H04R 3/02

(57) ABSTRACT

The present invention relates to a method for receiving data transmitted acoustically. The method includes the steps of receiving an acoustically transmitted signal; and decoding the signal using, at least, a first plurality of voters to extract the data. The first plurality of voters comprise differing values for a first acoustic characteristic to address interference. A system and software are also disclosed.

### FIELD OF INVENTION

The present invention is in the field of data communication. More particularly, but not exclusively, the present invention relates to a method and system for acoustic communication of data.

### BACKGROUND

There are a number of solutions to communicating data wirelessly over a short range to and from devices. The most typical of these is WiFi. Other examples include Bluetooth and Zigbee.

An alternative solution for a short range data communication is described in U.S. patent Ser. No. 12/926,470, DATA COMMUNICATION SYSTEM. This system, invented by Patrick Bergel and Anthony Steed, involves the transmission of data using an audio signal transmitted from a speaker and received by a microphone. This system involves the encoding of data, such as shortcode, into a sequence of tones within the audio signal.

This acoustic communication of data provides for novel and interesting applications. However, acoustic communication of data does involve unique problems. Specifically, because the signals are transmitted acoustically, the receiver receives a signal that may include a lot of interference created by the environment in which the signal is transmitted which may, for example, be reverberation (including early/late reflections). At the point of receiving the audio, distortions caused by interference have the effect of reducing the reliable data rates due to the decoder's increased uncertainty about a signal's original specification. For example, early reflections which are coherent but delayed versions of the direct signal, usually created from an acoustic reflection from a hard surface, may make it more difficult for a decoder to confidently determine the precise start or end point of a signal feature/note. This decreases overall reliability. It is therefore preferable to reduce these effects at the receiver. Otherwise the data encoded within the signal can be difficult to accurately detect. This can result in non-communication of data in certain environments or under certain conditions within environments.

There is a desire to improve the acoustic communication of data.

It is an object of the present invention to provide a method and system for acoustic communication of data which overcomes the disadvantages of the prior art, or at least provides a useful alternative.

### SUMMARY OF INVENTION

According to a first aspect of the invention there is provided a method for receiving data transmitted acoustically, including:
a) receiving an acoustically transmitted signal; and
b) decoding the signal using, at least, a first plurality of voters to extract the data;
wherein the first plurality of voters comprise differing values for a first acoustic characteristic to address interference.

The interference may be environmental interference.

The first acoustic characteristic may be one selected from the set of reverberation cancellation, timing offset, noise cancellation, and harmonics.

The environmental interference may be one or more of reverberation, reflections, echo, distortion, delay and noise.

The signal may be decoded using, at least, a second plurality of voters to extract the data, and wherein the second plurality of voters may comprise differing values for a second acoustic characteristic to address environmental interference. The second acoustic characteristic may be one selected from the set of FFT bins, timing offset, noise, and harmonics.

The first plurality of voters may be increased by one or more voters when the data cannot be successfully initially extracted.

The acoustically transmitted signal may be received at a first device. The signal may be decoded at the first device.

The first plurality of voters may further comprise differing values for a second acoustic characteristic to address environmental interference.

The signal may be decoded using, at least, a second plurality of voters, wherein the second plurality of voters may comprise differing values for an acoustic characteristic to address environmental interference.

The data may be encoded within the signal in accordance with an encoding format. The encoding format may include one or more of a header, error correction, and a payload. The error-correction may be Reed-Solomon. The encoding format may include encoding of data within the signal as a sequence of tones.

The signal may be decoded using a decoding method comprising:

Each voter reporting whether the encoding format is detected within the signal.

The decoding method may further comprise:

Using the error correction, selecting the voter which detects the least errors in the encoding format of the signal.

The decoding method may use a confidence interval for the voters.

Each of the voters may be pre-weighted.

The decoding method may further comprise:

Decoding the signal using consensus amongst the voters.

The decoding method may further comprise:

Decoding the signal using statistical information about the signal from at least some voters.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 2a: shows a diagram illustrating voters with different reverberation cancellation acoustic characteristics processing an audio signal in accordance with an embodiment of the invention;

FIG. 2b: shows a diagram illustrating voters with different timing offset acoustic characteristics processing an audio signal in accordance with an embodiment of the invention:

FIG. 3: shows a flow diagram illustrating a method in accordance with an embodiment of the invention; and

FIG. 4: shows a diagram illustrating an encoding format for an audio signal for use with a method in accordance with an embodiment of the invention.

### DETAILED DESCRIPTION OF PREFERRED EMBODIMENTS

The present invention provides a method and system for the acoustic communication of data.

The inventors have discovered that the audio signal, when it is received, could be processed by a plurality of different decoding engines. Each engine can be configured with different assumptions about the acoustic characteristics of the environment in which the audio signal was acoustically transmitted. The outputs from engines (called voters by the inventors) can then be used to more effectively decode the signal to extract the data encoded in the signal.

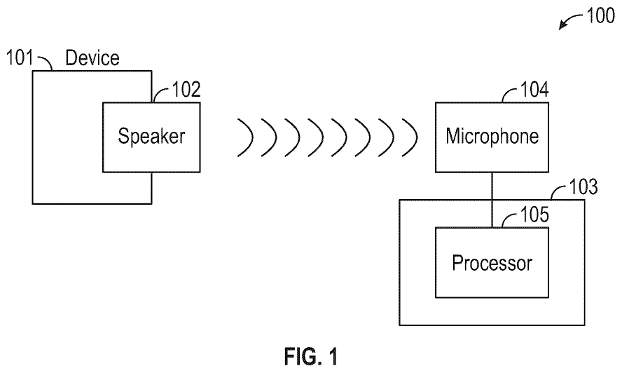

In FIG. 1, a system 100 in accordance with an embodiment of the invention is shown.

A first device is shown 101. This device 101 may include a speaker 102. The device 101 may be configured to acoustically transmit a signal, for example, via the speaker 102.

A second device 103 is shown. This second device 103 may include or be connected to a microphone 104. The microphone 104 may be configured to receive signals acoustically transmitted, for example, by the first device 101, and to forward those signals to one or more processors 105 within the second device 103.

The microphone 104 and the processor(s) 105 may be connected via a communications bus or via a wired or wireless network connection.

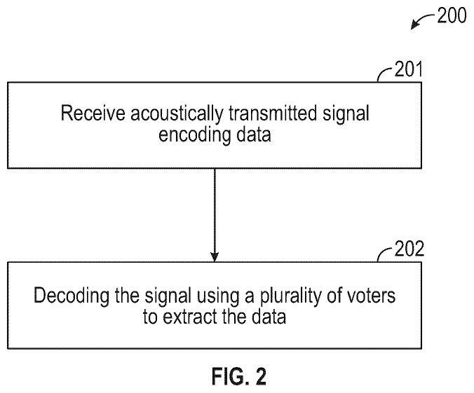

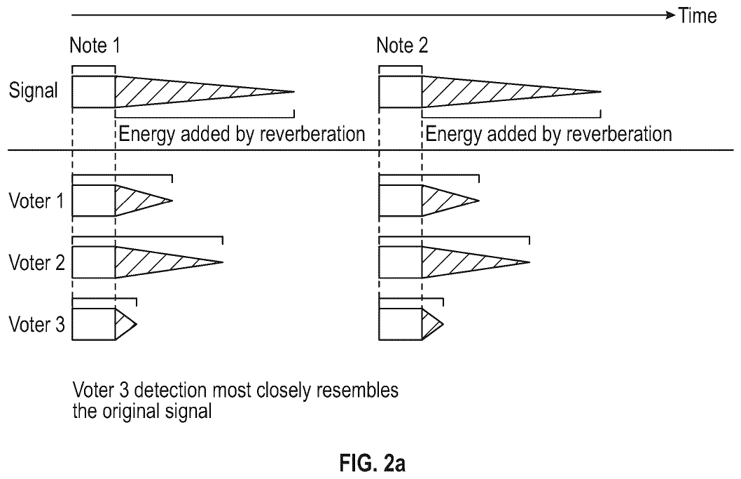

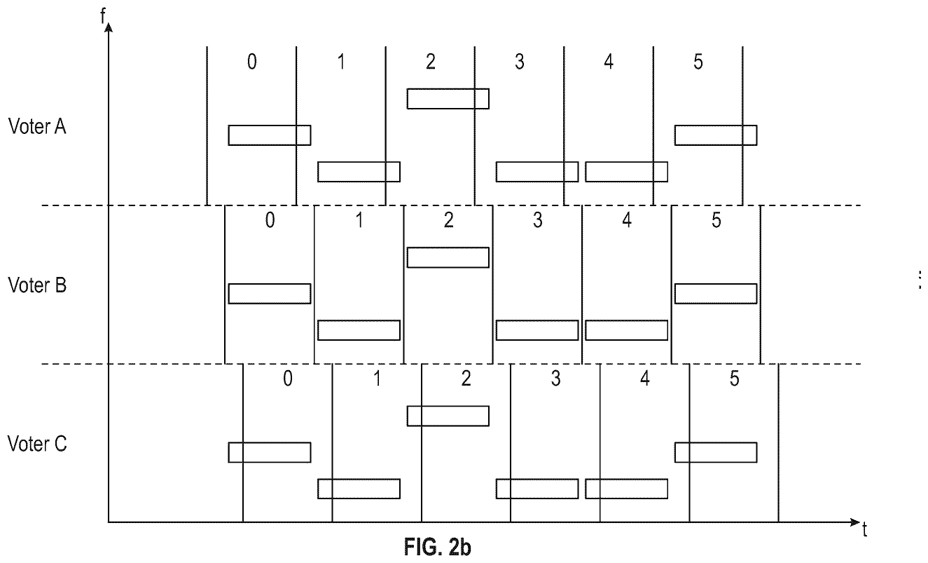

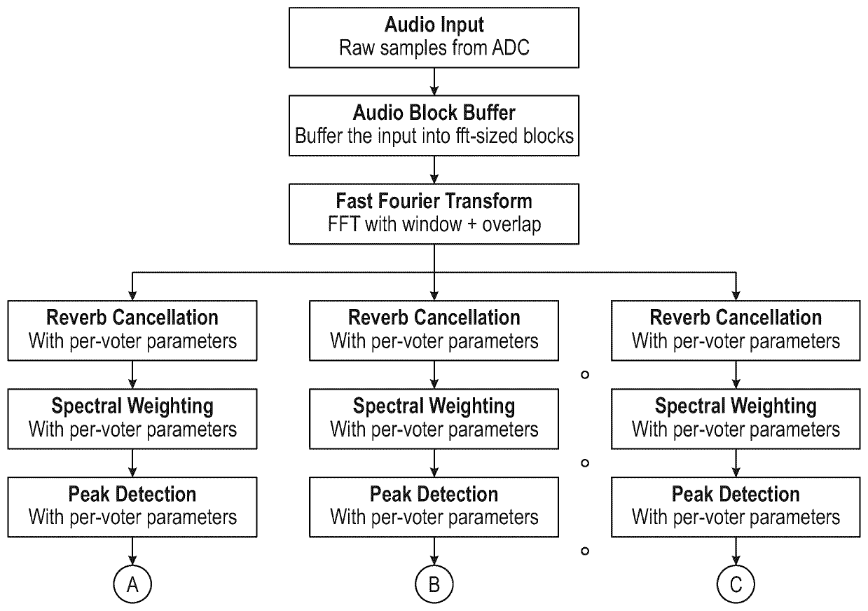

The processor(s) 105 may be configured to decode the received signal using a plurality of voters to extract data within the signal. The voters may be configured with differing values for an acoustic characteristic to address interference. The processor(s) 105 may be configured to perform the method described in relation to FIG. 2.

It will be appreciated by those skilled in the art that the above embodiments of the invention may be deployed on different devices and in differing architectures

Referring to FIG. 2, a method 200 for receiving acoustically transmitted data in accordance with an embodiment of the invention will be described.

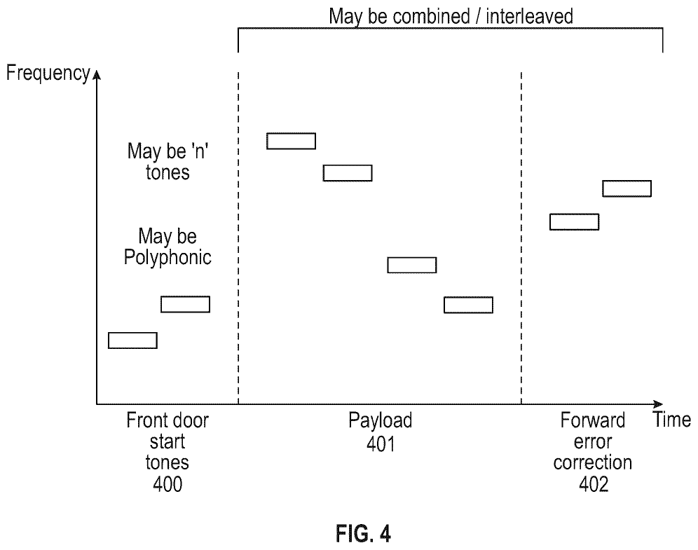

In step 201, an acoustically transmitted signal is received (for example, via microphone 104). The signal encodes data. The data may be, for example, encoded as a sequence of tones. The encoding format of the signal may include a header, error correction and a payload, it may also include a checksum. The error correction component of the transmitted signal may be in a separate part of the transmitted signal or may be interleaved or otherwise contained within the payload section. An example of an encoding format will be described later in relation to FIG. 4. Reed-Solomon may be used as error correction as well as other forms such as Hamming or Turbo Codes, for example. At least a part of the encoding of the data and/or encoding format of the signal may be performed as described in U.S. patent Ser. No. 12/926,470. The frequencies may be monophonic Frequency Shift Keying (FSK) or use a combination of frequencies to represent a data symbol similar to the DTMF encoding standard using Dual (or ‘n’) Tone Multiple Frequency Shift keying. The frequencies may be human audible or above the limit of human hearing (>20 kHz).

In step 202, the signal is decoded to extract data within the signal using a plurality of voters. The plurality of voters are configured within differing values for an acoustic characteristic to address interference (such as environmental interference). For example, the acoustic characteristic may be reverberation cancellation, timing offset, noise cancellation, or harmonics.

In examples where the acoustic characteristic is timing offset (e.g. where the environment creates interfering coherent, delayed versions of the direct signal), the values may be small artificial delays or advances in the relative positions of each voter with respect to the received input signal.

In examples where the acoustic characteristic is reverberation cancellation (e.g. where the environment creates reverberation interference), the values may be a reverb rolloff exponent (α) and/or a reverb cancellation magnitude (β), such that different voters will have different reverb rolloff exponent and reverb cancellation magnitude values. This is illustrated in FIG. 2a which shows voters 1, 2, and 3 with different reverberation cancellations attempting to detect a note (or tone) within a sequence of tones within the received audio signal.

The signal may be processed using a fast fourier transform (FFT) to produce bins of magnitudes across the spectrum. The FFT can be calculated on a per-frame basis. With the reverb cancellation values, the value passed to the decoder at a voter at a given frame t (Zₜ) is a combination of the current FFT magnitude (Xₜ) and a function of previous output values (Yₜ−1):

$${Y}_{t} = α {Y}_{1} - 1 + ( 1 - α ) {X}_{t}$$

$${Z}_{t} = {X}_{t} - β {Y}_{1} - 1$$

Where the reverb cancellation is characterised by two parameters.
α∈[0, 1]: reverb rolloff exponent, which should be selected proportionally to the length of the reverb tail of the acoustic environment; Typically close to 1.
β∈[0, 1]: reverb cancellation magnitude, which determine the degree to which reverb is subtracted from the magnitude of the current spectral frame.

In examples where the acoustic characteristic is timing offset (e.g. where the environment causes reflection or delay interference), the values may be offset values such that different voters will have offsets of different magnitude to accommodate different delays. This is illustrated in FIG. 2b which shows voters A, B. and C attempt to decode the same audio signal with a sequence of tones with different timing offsets.

In some embodiments, the plurality of voters may be configured with one or more further acoustic characteristics which may differ. Each of the further acoustic characteristics may be configured for addressing interference (such as environmental interference).

In some embodiments, a second plurality of voters are also used to decode the signal, this set of voters may have one or more of the same values for the acoustic characteristic as voters within the first plurality of voters, but may have a second acoustic characteristic that differs between them.

In some embodiments, one or more additional voters are added to the first set of voters when data cannot be successfully extracted.

In some embodiments, different voters may be configured to listen for a plurality of different encoding formats. These formats may be different in schema e.g. note length, definitions of ‘frontdoor’, payload and error correction components. These formats may also be separated by frequency, (e.g. in separate bands with one occupying a frequency range above or below the others), or with the frequencies of their notes interleaved or otherwise combined within the same total frequency range.

Furthermore, and in some embodiments, within step 202, the signal may be decoded using a decoding method where each voter reports a measure of confidence in the decoded signal. This may correspond to metrics from the acoustic space (for example, distance measures between ideal tone frequencies and analysed tone frequencies), or from the digital line coding schema (for example, minimising the number of errors corrected within Forward Error Correction, and/or using a binary measure of data integrity such as a checksum or CRC code).

The data extracted in accordance with the decoding provided by the selected voter may be identified as the data encoded within the signal. In some embodiments, a consensus method across the voters may be used to identify the data. In some embodiments, each of the voters may be pre-weighted. Statistical information from at least some of the voters may be used to decode the signal to extract the data.

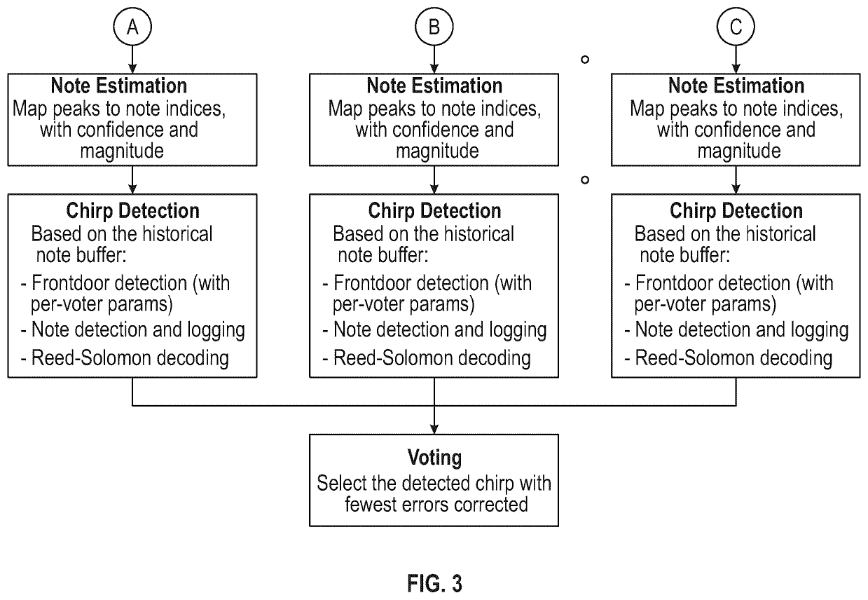

Referring to FIG. 3, a method and system in accordance with an embodiment of the invention will be described. In this embodiment, the audio signal will be termed a Chirp™ signal.

Voters are configured to differ with respect to their frame-offset, meaning the voters look at the timing of the signal differently from each other. This may enable the decoder as a whole to make a number of guesses regarding the actual start and end locations of each note (and the Chirp signal as a whole), thereby improving its detection accuracy by reducing the overlaps in detection between adjacent notes.

Typically the perceived timing of notes is altered due to the effects of reverb, making the addition of a de-reverberation step useful in conjunction with this timing offset.

Also the voters may apply reverb compensation differently (specifically different values of α & β as described in relation to FIG. 2)—this is particularly effective for tackling differences between different acoustic environments when where the Chirp signal is being played is not already known.

More generally, the voter characteristics may be tailored to be well suited in a variety of different acoustic conditions that decoders may face in real world scenarios. In embodiments, the voter system may not be optimised for one particular scenario, but made more robust to a very wide range of alterations caused by noise and acoustic effects during transmission.

In embodiments, this primarily is reverb cancellation, but could also include early/late reflections, room modes, echo, frequency dependent reverberation times, Doppler effects, background noise, harmonic distortion, adaptive filtering (to filter out any acoustic output of the decoding device), minimum confidence/magnitude thresholds for note detections (to have tolerant or intolerant voters), and others. Hardware characteristics could also be taken into account such as microphone and loudspeaker frequency responses.

For example, with respect to frequency dependent reverberation times each voter may have different expectations for reverberation decay rate at particular frequencies, these frequencies may correspond to frequencies that the encoder is expected to produce. The expected decay rate at each frequency then undergoes a reverberation cancellation process as described above.

It will be appreciated that different numbers of voters may be used. For example, the system may use five voters.

The number of voters may be selected based on the computation abilities of the processing device. It may also be adapted dynamically during operation based on the number of errors present during decoding. Additional voters with different parameters may be created if initial decoding with an existing voter set fails.

FIG. 3 illustrates the application of the voters for each frame of audio.
a) Each voter receives the output of the FFT for each frame of audio
b) The voter applies different timing and reverb compensation to the input, and keeps its own ‘history’/rolling average of its own output to be applied in the next frame.
c) Each voter declares whether or not it thinks it has decoded a Chirp signal (based on thresholds which also vary between voters), and also how many errors it has corrected during the Reed-Solomon error correction phase. Other results besides number of errors may be used to judge the ‘quality’ of a decoding. These results may include the distance between expected and measured pitch of particular tones or acoustic energy of each tone. A measurement of quality may also take into account the timing and measured duration of a note at the receiver, since the timing at the sending device is known and can be compared. It will be appreciated that different parameters can be combined in this way to produce an aggregated ‘confidence’ parameter which in turn can be used to select a preferred voter or subset plurality of voters.
d) If any voters have detected a Chirp signal, the voter with the least number of errors corrected, or highest confidence/quality measure, is chosen and the audio engine declares a Chirp signal having been heard.

### Alternative Embodiments

The embodiments described above in relation to FIG. 3 operate almost exclusively in the frequency domain—that is, after performing an FFT on the input signal. However, alternative embodiments may perform per-voter signal processing specifically for dereverberation as described above separately before performing the FFT and subsequent peak detection. In one example the input signal still represented in the time-domain is split into multiple channels, the number being equal to the number of voters present. Each channel is then modified using standard Finite Impulse Response, or Infinite Impulse Response filters, or standard convolution methods to modify each channel's and each subsequent voter's input signal before frequency analysis. In this embodiment, each filter is configured such that it amplifies particular frequencies present in the encoded signal. In another embodiment, each filter is configured such that it attenuates particular frequencies not present in the encoded signal. The modification to the signal before the FFT may also include gain or dynamic compression.

In some embodiments, the number and configuration of each voter can be increased and optimised based on the expected range of acoustic environments that the encoder-decoder pair will work in (i.e. for an industrial application with static, known acoustic characteristics, the number of voters can be decreased; while for a consumer mobile app expected to be taken into a wide variety of different acoustic contexts the number (and variety) of voters (and their parameter ranges) can be increased).

Referring to FIG. 4, an encoding format will be described. This encoding format comprises a header 400 which includes “front door” start tones. These tones may be the same across all audio signals encoding data within the system and can assist a receiver to determine when an audio signal encodes data. The encoding format further comprises a payload 401 and forward error correction 402. It can be seen that this encoding format defines the header 400, payload 401 and forward error correction 402 as comprising a sequence of tones across a frequency spectrum. Preferably this frequency spectrum includes or comprises the human-audible frequency spectrum. The tones may be monophonic or polyphonic.

A potential advantage of some embodiments of the present invention is improved reliability of data transmission across different acoustics. For example, when an acoustic transmission solution is required to work across a range of unknown acoustic environments (e.g. train stations to living rooms), the provision of multiple voters, each responding differently increases reliability across this range. Furthermore, in some embodiments, each voter can be individually optimised for different acoustic scenarios—including extreme parameter ranges—without adversely affecting the overall voting outcome. Thus as long as the characteristics of each voter varies considerably, diminishing returns may be avoided as voters are increased (when looking across a wide range of acoustic contexts).

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. An apparatus comprising:
a microphone;
a loudspeaker;
one or more processors; and
a non-transitory, computer-readable medium storing instructions that when executed by the one or more processors cause the apparatus to:
monitor an acoustic environment via the microphone while the loudspeaker is concurrently outputting an audio signal;
detect, via the microphone, an acoustic signal comprising data encoded as a sequence of tones;
determine at least one acoustic characteristic of the acoustic environment, wherein the at least one acoustic characteristic includes at least a measurement of interference generated by the audio signal in the acoustic environment;
dynamically adjust a number of active voters in a decoding engine based on the determined at least one acoustic characteristic, wherein adjusting the number of voters comprises increasing the number of active voters from a first quantity to a second quantity when the interference exceeds a threshold, wherein the second quantity is greater than the first quantity;
decode the acoustically transmitted data signal using the second quantity of active voters, wherein each voter of the second quantity is configured with a different value for a first acoustic characteristic of the at least one acoustic characteristic to address the interference; and
extract the data by selecting a result from the voter that identifies the fewest errors in the sequence of tones.

2. The apparatus of claim 1, wherein dynamically adjusting the number of active voters in the decoding engine based on the determined at least one acoustic characteristic comprises:
process the acoustic signal using the first quantity of active voters to obtain decoded data;
determine that a number of errors in the decoded data is greater than a threshold number of errors; and
based on the determined number of errors, increase the number of active voters to the second quantity of active voters.

3. The apparatus of claim 1, wherein the number of voters is based on computation ability of the one or more processors.

4. The apparatus of claim 1, wherein the at second quantity of active voters comprises differing values for the at least one acoustic characteristic to address the interference.

5. The apparatus of claim 2, wherein the differing values for the at least one acoustic characteristic to address the interference comprises differing values for reverberation decay at different frequencies.

6. The apparatus of claim 1, wherein the at least one characteristic of the acoustic environment comprises adaptive filter of the audio signal.

7. The apparatus of claim 1, wherein the at least one acoustic characteristic comprises: reverberation, reflections, echo, distortion, delay, or noise.

8. A non-transitory computer readable medium configured for storing computer-readable instructions that, when executed on one or more processors, cause one or more processors to:
monitor an acoustic environment via a microphone while a loudspeaker is concurrently outputting an audio signal;
detect, via the microphone, an acoustic signal comprising data encoded as a sequence of tones;
determine at least one acoustic characteristic of the acoustic environment, wherein the at least one acoustic characteristic includes at least a measurement of interference generated by the audio signal in the acoustic environment;
dynamically adjust a number of active voters in a decoding engine based on the determined at least one acoustic characteristic, wherein adjusting the number of voters comprises increasing the number of active voters from a first quantity to a second quantity when the interference exceeds a threshold, wherein the second quantity is greater than the first quantity;
decode the acoustically transmitted data signal using the second quantity of active voters, wherein each voter of the second quantity is configured with a different value for a first acoustic characteristic of the at least one acoustic characteristic to address the interference; and
extract the data by selecting a result from the voter that identifies the fewest errors in the sequence of tones.

9. The non-transitory computer readable medium of claim 8, wherein dynamically adjusting the number of active voters in the decoding engine based on the determined at least one acoustic characteristic comprises:
process the acoustic signal using the first quantity of active voters to obtain decoded data;
determine that a number of errors in the decoded data is greater than a threshold number of errors; and
based on the determined number of errors, increase the number of active voters to the second quantity of active voters.

10. The non-transitory computer readable medium of claim 8, wherein the number of voters is based on computation ability of the one or more processors.

11. The non-transitory computer readable medium of claim 8, wherein the at second quantity of active voters comprises differing values for the at least one acoustic characteristic to address the interference.

12. The non-transitory computer readable medium of claim 9, wherein the differing values for the at least one acoustic characteristic to address the interference comprises differing values for reverberation decay at different frequencies.

13. The non-transitory computer readable medium of claim 8, wherein the at least one characteristic of the acoustic environment comprises adaptive filter of the audio signal.

14. The non-transitory computer readable medium of claim 8, wherein the at least one acoustic characteristic comprises: reverberation, reflections, echo, distortion, delay, or noise.

15. A method, comprising:
monitoring an acoustic environment via a microphone of a device while a loudspeaker of the device is concurrently outputting an audio signal;
detecting, via the microphone, an acoustic signal comprising data encoded as a sequence of tones;
determining at least one acoustic characteristic of the acoustic environment, wherein the at least one acoustic characteristic includes at least a measurement of interference generated by an audio signal in the acoustic environment;
dynamically adjusting a number of active voters in a decoding engine based on the determined at least one acoustic characteristic, wherein adjusting the number of voters comprises increasing the number of active voters from a first quantity to a second quantity when the interference exceeds a threshold, wherein the second quantity is greater than the first quantity;
decoding the acoustically transmitted data signal using the second quantity of active voters, wherein each voter of the second quantity is configured with a different value for a first acoustic characteristic of the at least one acoustic characteristic to address the interference; and
extracting the data by selecting a result from the voter that identifies the fewest errors in the sequence of tones.

16. The method of claim 15, wherein dynamically adjusting the number of active voters in the decoding engine based on the determined at least one acoustic characteristic comprises:
processing the acoustic signal using the first quantity of active voters to obtain decoded data;
determining that a number of errors in the decoded data is greater than a threshold number of errors; and
based on the determined number of errors, increasing the number of active voters to the second quantity of active voters.

17. The method of claim 15, wherein the number of voters is based on computation ability of one or more processors.

18. The method of claim 15, wherein the second quantity of active voters comprises differing values for the at least one acoustic characteristic to address the interference.

19. The method of claim 16, wherein the differing values for the at least one acoustic characteristic to address the interference comprises differing values for reverberation decay at different frequencies.

20. The method of claim 15, wherein the at least one characteristic of the acoustic environment comprises adaptive filter of the audio signal.
